(19) United States
(12) Patent Application Publication
(10) Pub. No.: US 2011/0189441 A1
(43) Pub. Date: Aug. 4, 2011

(54) Protective Mat

(76) Inventor: Randy Lubart, Palm Beach Gardens, FL (US)

(21) Appl. No.: 12/697,750

(22) Filed: Feb. 1, 2010

(51) Int. Cl. B32B 3/30

(52) U.S. Cl. 428/166

(57) ABSTRACT

A floor mat is removable secured to a floor which enables individuals to use the floor in wet and slippery environments without slipping or falling on the floor. The floor mat includes an upper and a lower portion. The upper portion is secured to the lower portion at pre-selected areas. The lower portion includes raised portions. The lower portion is constructed and arranged to collect and retain fluids, such as water, which are passed through the upper portion. This construction prevents the dispersion of water and other fluids onto floors which presents a slip hazard to pedestrians.

### FIELD OF THE INVENTION

The present invention relates to protection of floors and surfaces from exposure to damaging liquids. In particular, the present invention relates to floor mats which prevent water and similar substances from damaging floors and other surfaces. Also the present invention prevents slips and falls.

### BACKGROUND OF THE INVENTION

Floors are subject to having liquids placed and/or spilled on them. The liquid makes the floors slippery, which in turn may lead to falls and injuries to persons traversing the floors. The floors of the entryways into many buildings are made from substances such as polished stones, polished woods, tile, etc. These substances are very slippery when water or other liquids are placed on them. When the weather is inclement, rain, snow or ice is brought into buildings by individuals. This results in the floors at the entryways of building being very slippery. While it would be desirable to have someone remove the water from the floors on a continual basis, this is not always possible. In many instances mats or carpets are temporary placed in these entryways to provide individuals with sound footing and prevent slips and falls.

In other areas, such as restaurants and commercial facilities where large amounts of water or other liquids are used, there is the danger that these liquids will get onto the floors and present a danger of slipping to individuals working in these areas. The floors in these areas are normally made from or covered by a material that can be subjected to water and liquids on a continual basis without damaging the floors. In some instances the floors in these areas are provided with drains to remove the water and liquids. However, this is not always practical and it is also relatively expensive. Alternatively, mats and/or carpets can be placed on these floors in the vicinity of work areas of individuals. However, in many instances these mats or carpets become saturated with water or liquids, thereby permitting the water to escape from the mats or carpets and afford hardly any protection against slips and falls by individuals. What is needed in the art is a floor mat which can be placed in an area which is exposed to fluids such as water and retain a significant amount of fluid. The upper surface of the floor mat should be made from a material which prevents an individual from slipping when the floor mat contains water. The floor mat should also prevent the distribution of fluids from the mat, thus containing the fluids to restricted areas of a floor.

### DESCRIPTION OF THE PRIOR ART

U.S. Pat. No. 4,731,275, issued to Anderson discloses a carpet tile assembly and process of manufacture. The carpet tiles have a tufted carpet layer and a second layer of elastomeric material vulcanized to the carpet layer. The second layer has a plurality of protrusions formed therein and a plurality of spikes on the protrusions which together engage a base layer. The base layer can be a mirror image of the second layer or a needle-punched or felt-like fiber mat to resist lateral movement of the carpet tiles.

U.S. Pat. No. 5,996,160, issued to Pruitt discloses an entry mat to permit the cleaning of shoes prior to entry into a house or building. The matt includes a plurality of rotatably mounted cylindrical brushes. The brushes are mounted above a reservoir of cleaning liquid. When a user rubs their shoes on the brushes, the brushes pick up cleaning liquid from the reservoir and place it on the bottom of the user's shoes. The dirt and liquid are then removed from the shoes by rubbing the shoes on another portion of the mat which contains liquid absorbing fabrics.

### SUMMARY OF THE INVENTION

A floor mat is removable secured to a floor which enables individuals to use the floor in wet and slippery environments without slipping or falling on the floor. The floor mat includes an upper and a lower portion. The upper portion is secured to the lower portion at pre-selected areas. The lower portion includes raised portions. The lower portion is constructed and arranged to collect and retain fluids, such as water, which are passed through the upper portion. The construction prevents the dispersion of water and other fluids onto floors.

Accordingly, it is an objective of the instant invention to provide a floor mat including a slip resistant upper portion and a lower portion designed to retain fluids, such as water.

It is yet another objective of the instant invention to provide a floor mat wherein an upper portion is secured to a lower portion at pre-selected locations thus enabling a large amount of fluid to be retained by the lower portion.

It is a still further objective of the invention to provide a floor mat made from materials which repel fluids so that the fluids can readily be removed from the floor mat and the floor mat can be readily cleaned.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top perspective view of the present invention;

FIG. 2 is a top plan view of the present invention;

FIG. 3 is a bottom view of the present invention;

FIG. 4 is a cross sectional view of the present invention along line 4-4 in FIG. 2;

FIG. 5 is a top view of a portion of the present invention with the top fabric layer removed;

FIG. 6 is an enlarged view of a top corner of the present invention; and

FIG. 7 is an enlarged view of a bottom corner of the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

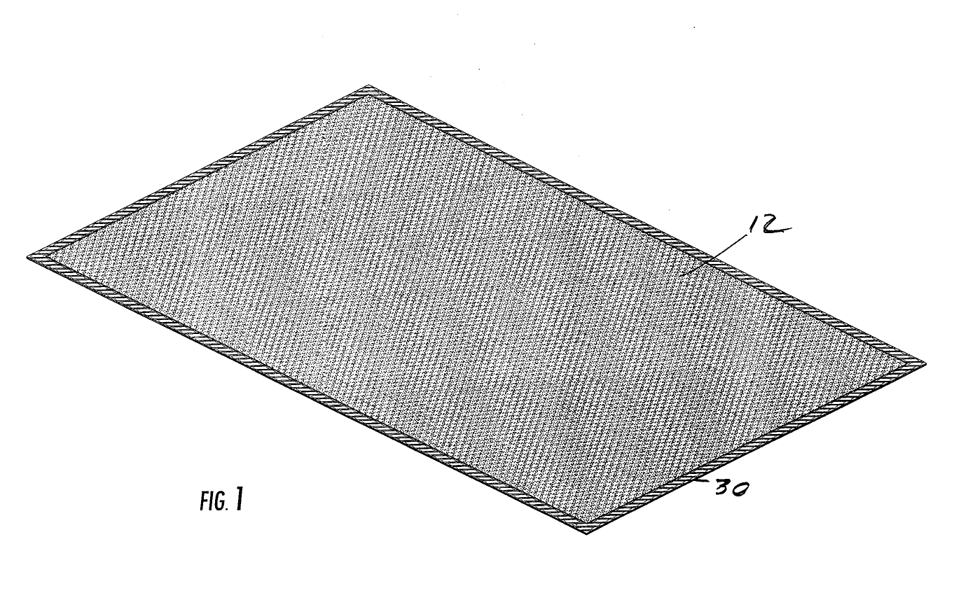

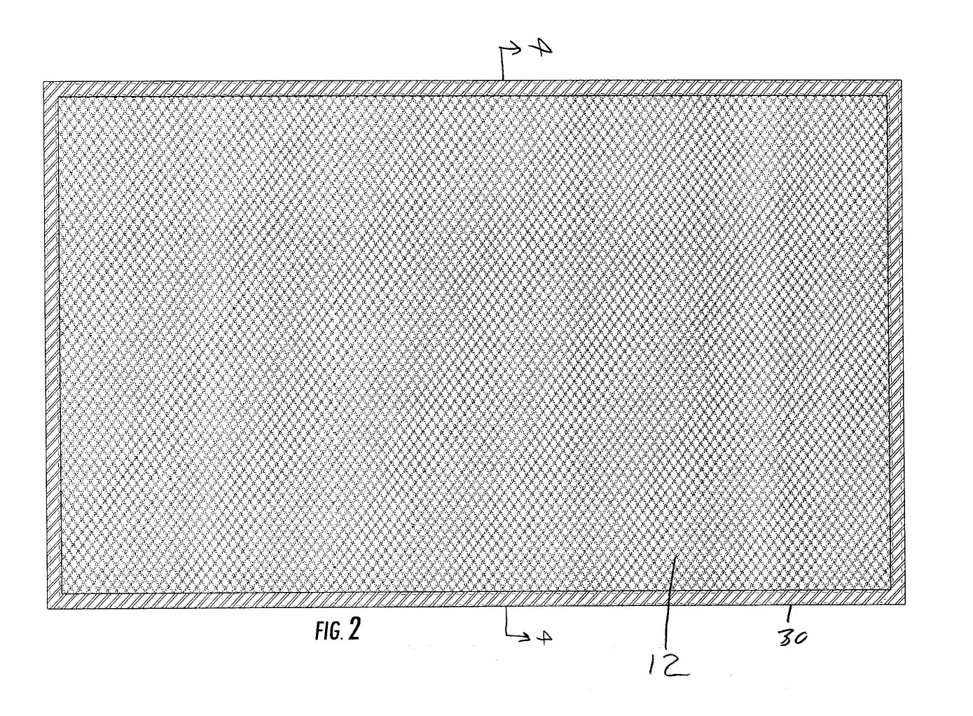

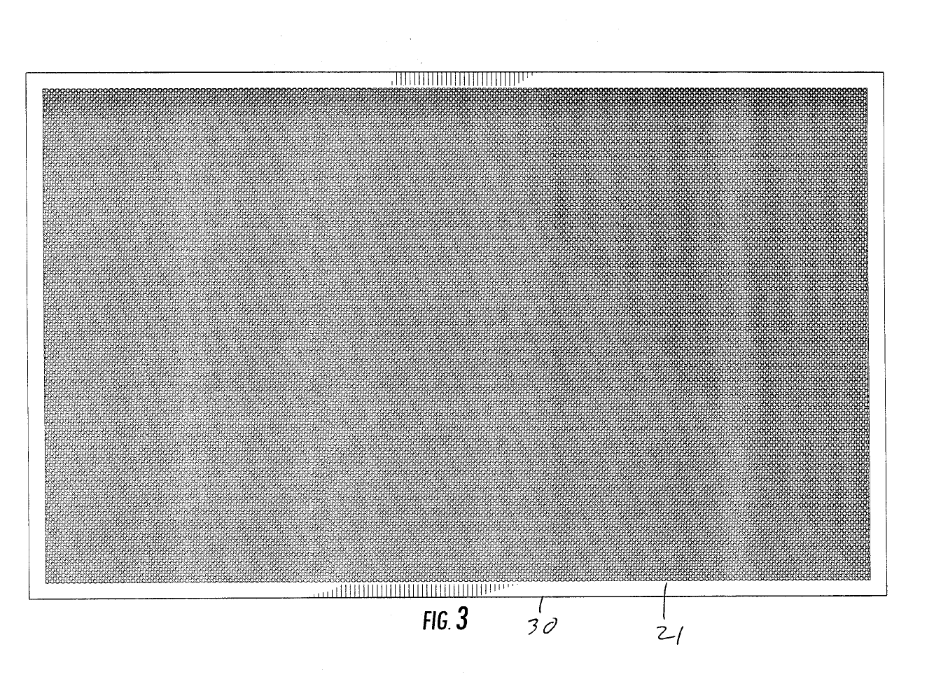

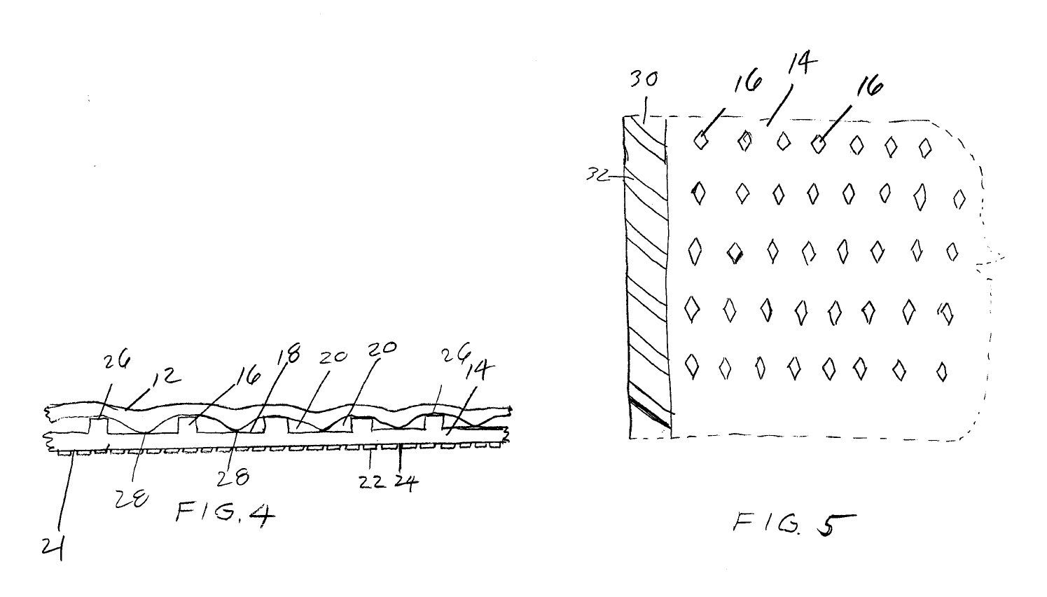

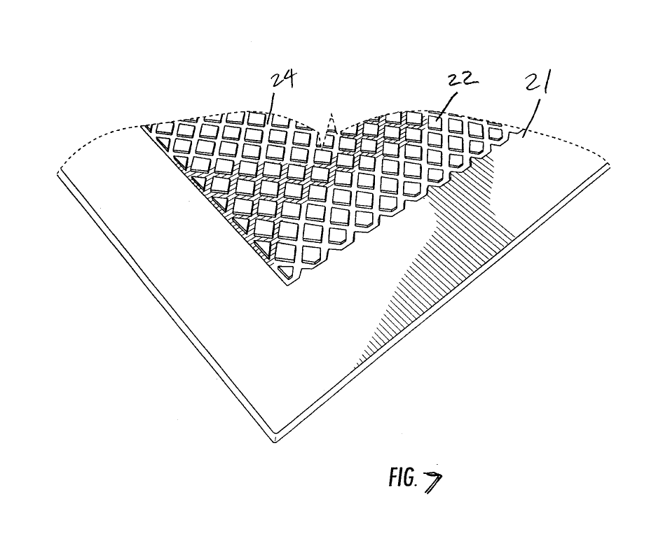

Referring now to FIGS. 1-7, a preferred embodiment of the present invention will now be described. As shown, a floor mat 10 includes an upper portion or layer 12 and a lower portion or layer 14. The upper portion 12 is positioned vertically above the lower portion 14 and is secured to the lower portion in a manner which will be described herein after. Both the upper portion and lower portion are substantially planar. The upper portion is preferably a needle punched or felt-like fiber layer. The upper portion is preferably made from polyester and polypropylene fibers. While these materials are preferred, any materials which are hydrophilic can be utilized.

These mats are preferable utilized in areas where there are relatively large amounts of water and other fluids present. These areas are so-called wet or oily environments. In these environments the combination of heavy pedestrian traffic and the presence of water, oil, grease, food, other liquids or semi-liquid substances creates a hazard to the pedestrians. Accordingly, it would be desirable to separate the fluids from underfoot of the pedestrians.

One of the problems associated with the floor mats currently available is that after a period of time the mats become saturated with water or other fluids. The situation leads to the fluids spilling over the edges of the mats and onto the floors. This then presents a hazard to pedestrians. For example, when the floor mats are used in the entranceways of buildings, heavy pedestrian traffic in inclement weather will deposit a substantial amount of water, snow or ice onto the mats. If the mats are not cleaned on a regular basis the water, snow or ice will flow over the edges of the mat and onto the floor thereby presenting a slip hazard to pedestrians. In other environments, such as restaurants or the food preparation industry, oils, grease and foods can fall onto these mats. Again, if these mats are not cleaned on a regular basis the excess amounts of grease, oils and food will spill over the edges of the mats and onto the floor.

One solution to this problem would be to retain or contain the water or other fluids within or onto the mat so as to avoid the distribution of these fluids onto floors and other areas where individuals would be walking or working. The present invention solves this problem by providing a reservoir or container to hold or contain the fluids which fall onto or are placed onto the mat 10. The lower portion 14 of the mat forms the reservoir or container. It is preferably made from vulcanized rubber. It could also be made from other materials, such as PVC or thermo plastics. The lower portion 14 is constructed and arranged to hold the water or fluids which pass through the upper portion 12 of the mat 10. The fluid capacity of the lower portion 14 of the mat will be sufficient to retain any water or fluids placed onto the upper portion for the period of time that the mat is in service before being removed or cleaned. The large fluid capacity of the lower portion 14 of the mat 10 enables the present invention to be placed in service and remain in service substantially longer than currently available floor mats.

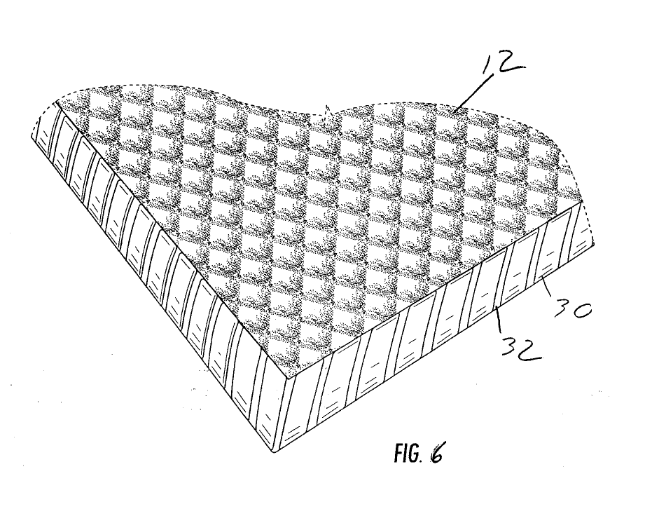

One of the unique features of the present invention is the projections or ribs 16 that are formed onto the upper surface 18 of the lower portion 14. The projections 16 can be formed separately from the lower portion 14 and subsequently secured thereto. Alternatively, the projections 16 can be molded or formed onto the lower portion when the lower portion is formed. Projections 16 are preferably diamond shaped when viewed from above, as illustrated in FIG. 5. They can also be any other shape. The projections function to displace portions of the upper portion 12 of the mat away from the lower portion 14 thereby forming channels or troughs 20. These channels or troughs 20 retain the water and fluids which pass through the upper portion 12. They provide the relative larger fluid capacity of the mat. In addition, by removing water and other fluids from the upper portion 12 of the mat, they enable the upper portion 12 to remain relatively dry and avoid a slip hazard for pedestrian traffic.

The lower surface 21 or underside of the lower portion has a plurality of ribs or projections 22 formed thereon. The ribs 22 are preferably molded or formed onto the lower portion when the lower portion is formed. The ribs 22 can also be formed separately from the lower portion 14 and subsequently secured thereto. These ribs or projections 22 help to secure the mat 10 to floors and surfaces which contain water or other fluids. These ribs displace the water or fluids from underneath the mat through the spaces 24 between the ribs and thus present a relativity dry surface onto which the mat is placed. This prevents the mat from slipping or moving in wet environments.

The upper portion 12 comprises a material which provides a surface that is resistant to slipping even when wet. Since the material of layer 12 is hydrophilic, it will attract water or fluids. Thus it will tend to remove water and fluids from the shoes of individuals who stand on or walk across the mats. Once the upper portion becomes saturated with water or other fluids, the water or fluids will flow downwardly toward the lower portion 14. The upper portion is preferably a needle punched or felt-like fiber layer. The upper portion is preferably made from polyester and polypropylene fibers. While these materials are preferred, any materials which are hydrophilic can be utilized.

The upper portion is secured to the lower portion at the tops 26 of the projections 16 and at select points 28 on the upper surface 18 of the lower portion. The upper portion is preferably secured to lower portion at both points 26 and 28 utilizing adhesives. The upper and lower portions could also be vulcanized together. The advantage to having the upper portion secured to the lower portion at only select points, rather than all along the entire lower surface of the upper portion, is that channels or troughs 20 are formed. These channels or troughs 20 retain the water and fluids which pass through the upper portion 12. They provide the relative larger fluid capacity of the mat of the present invention compared to comparable state of the art floor mats.

An edging 30 is secured around the periphery of mat 10. The edging 30 is preferably formed as a part of the lower portion by molding. However, the edging 30 can also be formed as a separate element and secured to the lower portion 14 by adhesive, vulcanization, etc. Edging 30 is preferably with channels 32 on its upper surface. The edging can also be formed without the channels.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A floor mat for placement on a surface subject to a wet environment comprising:
a lower portion;
an upper portion, said upper portion comprised of a material having properties which will permit fluids from an upper surface of said material to pass through said material to a lower portion of said material;
said lower portion includes a lower surface, an upper surface and raised projections;
said raised projections are secured to said upper surface of said lower portion;
said upper portion is secured to said lower portion at said upper surface and said raised portions, whereby fluids placed on said floor mat are passed through said upper portion to said lower portion thereby leaving said upper portion free of fluids.

2. The floor mat of claim 1 including an edging secured to a periphery of said lower portion.

3. The floor mat of claim 1 wherein said upper portion is secured to said lower portion at pre-selected spots, on said raised projections and said upper surface of said lower portion.

4. The floor mat of claim 3 wherein said upper portion is spaced from and not secured to said lower portion at locations between said pre-selected spots on said raised projections and said upper surface of said lower portion thereby forming fluid channels.

5. The floor mat of claim 4 wherein fluids placed on said floor mat are transferred from said upper portion to said lower portion and collected in said channels.

6. The floor mat of claim 3 wherein said upper portion is secured to said lower portion by an adhesive.

7. The floor mat of claim 2 wherein said edging is secured to the entire periphery of said lower portion.

8. The floor mat of claim 1 wherein said upper portion is composed of a material which is hydrophilic.

9. The floor mat of claim 1 including a plurality of ribs on the lower surface of the lower portion, a plurality of channels adjacent said ribs and separating said ribs from one another.
